(19) United States
(12) Patent Application Publication
(10) Pub. No.: US 2010/0012782 A1
(43) Pub. Date: Jan. 21, 2010

(54) Aircraft With Modular Structure

(75) Inventors: Claus Hoffjann, Hamburg (DE); Hans-Georg Schuldzig, Jork (DE)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Airbus Deutschland GmbH, Hamburg (DE)

(21) Appl. No.: 12/086,958

(22) PCT Filed: Dec. 15, 2006
(86) PCT No.: PCT/EP2006/012142

§ 371 Date: Sep. 18, 2009

Related U.S. Application Data
(60) Provisional application No. 60/750,955, filed on Dec. 16, 2005.

(30) Foreign Application Priority Data
Dec. 16, 2005 (DE) 10 2005 060 369.6

(51) Int. Cl. B64C 1/00; B64F 5/00

(52) U.S. Cl. 244/120

(57) ABSTRACT

An aircraft includes a module carrier for accommodating a plurality of module elements in which in each case at least one system element is integrated. The module elements and system elements are networked among each other such that a desired aircraft model is implemented.

### REFERENCE TO RELATED APPLICATIONS

This application claims the benefit of the filing date of German Patent Application No. 10 2005 060 369.6 filed Dec. 16, 2005 and of U.S. Provisional Application 60/750,955 filed Dec. 16, 2005, the disclosure of which applications is hereby incorporated herein by reference.

### FIELD OF THE INVENTION

The invention relates to an aircraft with modular structure.

### TECHNICAL BACKGROUND OF THE INVENTION

In aircraft, especially for civil aviation, there are particularly stringent requirements relating to the flexibility of equipment- and performance characteristics.

### SUMMARY OF THE INVENTION

It is the object of the invention to create an aircraft that can be flexibly adapted to different equipment- and performance characteristics.

This object is met as disclosed in claim 1. Advantageous embodiments of the invention are stated in the dependent claims.

According to an exemplary embodiment of the invention an aircraft comprises a module carrier for accommodating a plurality of module elements in which in each case at least one system element is integrated. The system elements assume individual tasks that are necessary in relation to the aircraft or the flight mission. In this arrangement it is also possible for several system elements to be present within one module element.

By changing individual or all modules, in this way it is possible to achieve different equipment- and performance variants of the same aircraft model. Furthermore, by leaving out individual module elements that are not required at the time for a particular mission, it becomes possible to activate savings potentials by means of a reduction in weight.

In each case the module elements and/or the system elements are networked among each other. By networking system elements also among different module elements, the capability of the overall system can be influenced or adapted. Furthermore, with this design the balance of the aircraft can be influenced.

According to another exemplary embodiment of the invention, it is possible to design passenger module elements that are boarded by passengers, or to design freight module elements that are filled with freight, while these module elements are outside the aircraft, with said module elements subsequently being placed in a corresponding accommodation device of the aircraft. Furthermore, it is possible for these passenger modules or freight modules to be moved (transported) also by other means of transport, for example by rail, ship, etc.

### SHORT DESCRIPTION OF THE DRAWINGS

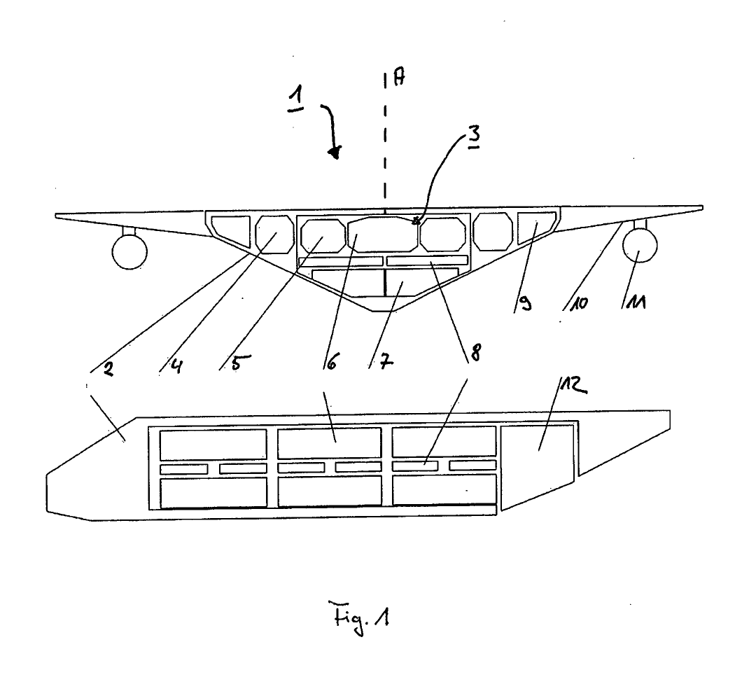

Below, with reference to FIG. 1, an exemplary embodiment of the invention is described.

### DETAILED DESCRIPTION OF EXEMPLARY EMBODIMENTS

FIG. 1 shows a cross section and a longitudinal section of an aircraft 1 which comprises a modular design, according to the an exemplary embodiment. The aircraft 1 comprises a module carrier 2 for accommodating a plurality of module elements 3 to 9, which will be described in detail later.

As shown in FIG. 1, the module carrier 2 comprises a fuselage of any shape with at least one aerofoil 10. The aerofoil or wing 10 and the fuselage of the aircraft 1 can for example be a combined component.

According to the exemplary embodiment, the aerofoil 10 comprises an external system module 11, for example an auxiliary tank. Although not shown in the figure, a plurality of such external modules can be affixed to the outside of the aerofoil 10 or the fuselage of the aircraft 1.

According to the exemplary embodiment, the fuselage of the aircraft 1 comprises two freight modules 7 in order to accommodate freight (not shown). Above the freight modules 7 in each case there are floor modules 8. According to the exemplary embodiment, above the floor modules 8 there are passenger modules 5, 6 for accommodating passengers.

Furthermore, according to the exemplary embodiment, the aircraft 1 comprises propulsion modules 4 to generate movement of the aircraft 1 and thus a flow against the aerofoil 10, which flow is necessary to generate lift.

According to the exemplary embodiment, the aircraft 1 further comprises two tank modules 9, which are arranged in the fuselage of the aircraft 1.

As shown in FIG. 1, according to the exemplary embodiment the above-mentioned module elements 4, 5, 7, 8 and 9 are arranged symmetrically on an axis A. The passenger module element 6 is preferably symmetrically divided by the axis A. Any desired number of the above-mentioned module elements and any desired arrangement (including an asymmetrical arrangement) can be used.

In each instance the above-mentioned module elements comprise integrated system elements that are networked among each other. Furthermore, the individual module elements or their integrated system elements are networked with each other so as to meet a required equipment- and performance characteristic of the aircraft 1.

FIG. 1 further shows a supply-/disposal element for supplying the aircraft 1 for example with hydrocarbon-based fuel, hydrogen, oxygen, water, any gases, liquids and/or solids. Furthermore, the supply-/disposal module element 12 is used for the disposal of at least waste water, any gases, liquids and/or solids.

Although the invention was described with reference to an exemplary embodiment, it is of course possible to make modifications and changes without leaving the protective scope of the invention.

For example, other module elements, either more or fewer of them, can be used, depending on the respective requirements relating to the aircraft 1 or to the aircraft mission.

Furthermore, the system elements integrated in the individual module elements can be any imaginable system elements, for example comprising: a hydraulic system element; a pneumatic system element; an energy supply system element; an electrical system element; a cooling system element; an air conditioning system element; a water supply system element; a waste water disposal system element; a gas supply system element; a liquid supply system element; an exhaust gas disposal system element; a liquid disposal system element; a communication system element; a control system element; a data transmission system element; an emission element for heat or light; an element for functions of the aircraft operation; an element for safety functions; an element for comfort or the supply to passengers or crew; an element for the transport of passengers, for example a seating cabin or a sleeping cabin; an element for the transport of freight, etc.

Any number and any type and manner of the above-mentioned individual system elements can be integrated in the individual above-mentioned module elements.

### LIST OF REFERENCE CHARACTERS

1 Aircraft

2 Module carrier

3 Module element

4 Propulsion module element

5 Passenger module element

6 Passenger module element

7 Freight module element

8 Floor module element

9 Tank module element

10 Aerofoil/Wing

11 External module element

12 Supply-/disposal module element

1. An aircraft comprising:
a module carrier;
a plurality of module elements;
a plurality of integrated system elements;
wherein the module carrier accommodates the plurality of module elements;
wherein each module element comprises at least one integrated system element; and
wherein a module element comprises one or more of a propulsion unit for propelling the aircraft, a lift unit for generating lift of the aircraft, and/or a transport unit for the transport of passengers or freight.

2. The aircraft of claim 1, wherein the module elements are individually exchangeable.

3. The aircraft of claim 1, wherein the system elements in the case of an installed or deinstalled module element are arranged to be exchangeable.

4. The aircraft of claim 1, wherein the module elements form a network.

5. The aircraft of claim 1, wherein the system elements form a network.

6. The aircraft of claim 4, wherein the network comprising module elements reflects an overall function.

7. The aircraft of claim 5, wherein the network comprising system elements reflects an overall function.

8. The aircraft of claim 4, wherein the network comprising module elements is arranged to be redundant.

9. The aircraft of claim 1, wherein the module elements are arranged to be combinable such that different variants of an aircraft model can be implemented.

10. The aircraft of claim 1, further comprising identical module elements provided with different system elements such that different variants of an aircraft model can be implemented.

11. The aircraft of claim 9, wherein all the module elements within the same aircraft model or with other aircraft models of the same design are exchangeable, wherein the aircraft models may differ as far as their size, flying range and performance data are concerned.

12. The aircraft of claim 1, wherein the module elements can be assembled, loaded, or boarded by passengers while said module elements are outside the aircraft.

13. The aircraft of claim 1, wherein the module elements are movable by another transport system.

14. The aircraft of claim 1, wherein the module carrier comprises at least one fuselage, and at least one aerofoil, with the fuselage and the aerofoil forming a combined component.

15. The aircraft of claim 1, wherein the module carrier comprises a module element that forms at least part of the fuselage and/or of an aerofoil.

16. The aircraft of claim 15, wherein the module element is situated within the fuselage or the aerofoil and is accessible from the outside on the fuselage or the aerofoil, or forms part of the fuselage structure or the aerofoil structure.

17. The aircraft of claim 1, wherein at least one module element is used for the supply to the aircraft, and at least one module element is used for disposal from the aircraft.

18. The aircraft of claim 17, wherein the supply module element supplies the aircraft with at least one of the following media: hydrocarbon-based fuel, hydrogen, oxygen, water, gases, liquids or solids.

19. The aircraft of claim 17, wherein the disposal module is used for the disposal of at least one of the following media: waste water, gases, liquids or solids.

20. The aircraft of claim 1, wherein the system element comprises at least one of the following: a hydraulic system element; pneumatic system element; energy supply system element; electrical system element; cooling system element; air conditioning system element; water supply system element; waste water disposal system element; gas supply system element; liquid supply system element; exhaust gas disposal system element; liquid disposal system element; communication system element; control system element; data transmission system element; emission element for heat or light; element for functions of the aircraft operation; element for safety functions; element for comfort or the supply to passengers or crew; element for the transport of passengers; or element for the transport of freight.

21. The aircraft of claim 5, wherein the network comprising module elements reflects an overall function.

22. The aircraft of claim 6, wherein the network comprising system elements reflects an overall function.

23. The aircraft of claim 21, wherein the network comprising system elements reflects an overall function.

24. The aircraft of claim 5, wherein the network comprising the systems element is arranged to be redundant.

25. The aircraft of claim 10, wherein all the module elements within the same aircraft model or with other aircraft models of the same design are exchangeable, wherein the aircraft models may differ as far as their size, flying range and performance data are concerned.
